(19) United States
(12) Patent Application Publication
(10) Pub. No.: US 2024/0086901 A1
(43) Pub. Date: Mar. 14, 2024

(54) METHOD AND SYSTEM FOR SECURE EXCHANGE OF USER COOKIE-DATA AND USER INTERACTIONS FOR CRYPTOCURRENCY

(71) Applicant: Nelson Tizeo de Paula Moreira, Toronto (CA)

(72) Inventor: Nelson Tizeo de Paula Moreira, Toronto (CA)

(21) Appl. No.: 18/263,874

(22) PCT Filed: Feb. 4, 2021
(86) PCT No.: PCT/IB2022/050791

§ 371 Date: Aug. 1, 2023

Related U.S. Application Data
(60) Provisional application No. 63/199,944, filed on Feb. 4, 2021.

(51) Int. Cl. G06Q 20/36

(52) U.S. Cl. CPC G06Q 20/3678

(57) ABSTRACT

Provided is a system and method for secure exchange of user cookie-data and user interactions with a mining station for cryptocurrency. The method including: associating a cryptocurrency wallet with each user; receiving mining information from the mining station, the mining information including user interactions associated with one of the users at the mining station; and distributing cryptocurrency to the cryptocurrency wallet associated with each user based on the mining information associated with such user.

### TECHNICAL FIELD

The following relates generally to data processing, and more specifically, to a method and system for secure exchange of user interactions for cryptocurrency.

### BACKGROUND

Users of various online websites, applications, and services often have to provide their data, including identifying information and browsing habits, in order to use such websites and services. These provisions of data are often obscured to the user and become susceptible to privacy rights concerns. In addition, other than not use services that are often times ubiquitous and unavoidable, the user has no other choice but to accept such release of their data and generally receive nothing else in return.

### SUMMARY

In an aspect, there is provided a method for secure exchange of user cookie-data and interactions at a mining station for cryptocurrency, the method executed on at least one processing unit of a computing device, the method comprising: associating a cryptocurrency wallet with each user; receiving mining information from the mining station, the mining information comprising user interactions associated with one of the users at the mining station; and distributing cryptocurrency to the cryptocurrency wallet associated with each user based on the mining information associated with such user.

In a particular case of the method, the method further comprising authenticating each user, each mining station, or both.

In another case of the method, the method further comprising associating each user with a mining station comprising receiving user identifying information at the mining station.

In yet another case of the method, the user identifying information comprises the identification of the cryptocurrency wallet of the user.

In yet another case of the method, the method further comprising adding coins mined at the mining stations to a centralized wallet, and wherein the cryptocurrency distributed to the cryptocurrency wallet associated with each user is taken from the centralized wallet.

In yet another case of the method, the cryptocurrency distributed from the centralized wallet is distributed periodically.

In yet another case of the method, the received mining information is added to a mining data table, and the distribution of cryptocurrency is based on the information stored in the mining data table.

In yet another case of the method, the distribution of cryptocurrency to the cryptocurrency wallet is governed by a platform contract between the mining station and the user.

In yet another case of the method, each platform contract between users and mining stations provides cryptocurrency based on predetermined types of user cookie-data and user interactions of the user at the mining station.

In yet another case of the method, user interactions include at least one of time spent by the user on a platform associated with the mining station and data provided by the user to the mining station.

In another aspect, there is provided a system for secure exchange of user cookie-data and interactions at a mining station for cryptocurrency, the system comprising one or more processors in communication with a data storage, the data storage comprising instructions to execute: a user module to associate a cryptocurrency wallet with each user; a mining module to receive mining information from the mining station, the mining information comprising user interactions associated with one of the users at the mining station; and a release module to distribute cryptocurrency to the cryptocurrency wallet associated with each user based on the mining information associated with such user.

In a particular case of the system, the user module further authenticates each user, each mining station, or both.

In another case of the system, the user module further associates each user with a mining station comprising receiving user identifying information at the mining station.

In yet another case of the system, the user identifying information comprises the identification of the cryptocurrency wallet of the user.

In yet another case of the system, the mining module adds coins mined at the mining stations to a centralized wallet, and wherein the cryptocurrency distributed to the cryptocurrency wallet associated with each user is taken from the centralized wallet.

In yet another case of the system, the cryptocurrency distributed from the centralized wallet is distributed periodically.

In yet another case of the system, the received mining information is added to a mining data table, and the distribution of cryptocurrency is based on the information stored in the mining data table.

In yet another case of the system, the distribution of cryptocurrency to the cryptocurrency wallet is governed by a platform contract between the mining station and the user.

In yet another case of the system, each platform contract between users and mining stations provides cryptocurrency based on predetermined types of user cookie-data and user interactions of the user at the mining station.

In yet another case of the system, user interactions include at least one of time spent by the user on a platform associated with the mining station and data provided by the user to the mining station.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of an environment for secure exchange of user interactions for cryptocurrency, in accordance with an embodiment;

FIG. 2 is a schematic diagram showing a system for secure exchange of user interactions for cryptocurrency, in accordance with an embodiment;

FIG. 3 is a flowchart showing a method for secure exchange of user interactions for cryptocurrency, in accordance with an embodiment;

FIG. 4 is a flowchart showing another method for secure exchange of user interactions for cryptocurrency, in accordance with another embodiment;

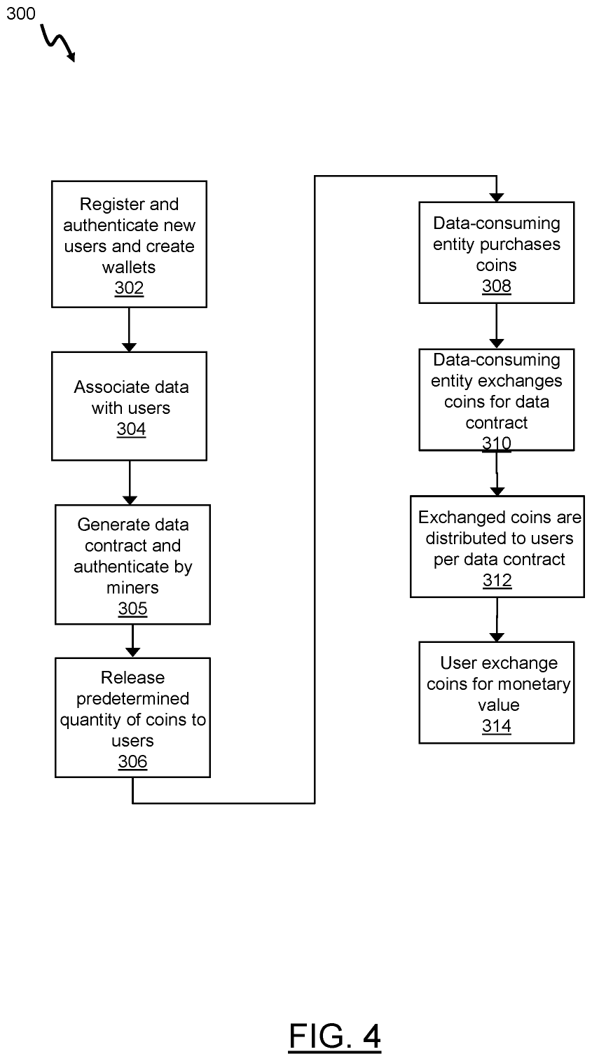

FIG. 5 illustrates a conceptual diagram illustrating interactions between elements of the environment of FIG. 1, in accordance with the method of FIG. 4; and

FIG. 6 is a flowchart showing a method of exchanging smart contracts to execute the exchange of data for coins, in accordance with the method of FIG. 4.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor, as a plurality of processors, as a multi-core and/or multi-threaded processors, or the like. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to data processing, and more specifically, to a method and system for enabling monetization and value exchange of data in a secure and scalable blockchain environment. The present embodiments provide a number of substantial advantages, for example: the ability to price data, which is an abstract commodity, by creating technological data contracts; the ability to ensure privacy for users of various websites and online services; the ability to provide an automated market-priced commoditized value to a cryptocurrency; and the ability to create a bridge between consuming entities and internet users that automatically enables monetization.

With respect to web-browsing, third-party cookies are used to save information, and in some cases, target users with advertisements; enabling the advertised message to be distributed to the right audience. However, cookies can be used with nefarious purposes, for example, disregarding users' privacy and monetizing their data. With little control of how their data is used, other than to outright not accept cookies that could ‘break’ websites and other internet assets, users' data is being used to increase the wealth of private organizations and without properly benefiting the person whose data is being used. Advantageously, the present embodiments provide a technological solution to provide a market value to users' data with the use of a decentralized asset; which is platform agnostic. Through the use of a cryptographic coin implementation, mining stations can act as mining stations and their users' data or attention can be translated into such cryptographic coin. In this way, the mining stations, acting as mining stations, are required to share profit with their users by purchasing the cryptocurrency mined in exchange for having access to data. In some cases, inflationary pressures on the value of the cryptocurrency coin can be prevented with the use of a smart contract. The smart contract also ensures that value-added to the currency will be retained and potentially increase as data continues to be consumed.

Some approaches to cryptocurrencies include generating cryptocurrency ‘coins’ through different approaches. Typically, within a small community, either by use of computing resources (for example, solving algorithms), commonly referred to as mining, or by having such coins generated as determined by the cryptocurrency platform, for example by an initial coin offering (ICO). Generally, the generated coins have little intrinsic value other than the promises by the platform owners that the coins can be used and exchanged over the platform. Both scenarios generally lack fair distribution of coins among the prospective users but instead centralizes them into a small community of people (usually initial coin offering investors and miners).

Some approaches to enable data monetization have been proposed to create social media platforms or data storage platforms that incentivize use and data sharing with the exchange of cryptocurrency. However, these platforms require migrating users to use these services instead of more established and popular platforms.

Some publishers have realized that asking permission to show relevant advertisements would not be enough to access users' data, as people have been using technology to block advertisements. In response, some approaches have been to incentivize the sharing of data. For example, using a points system to reward users or a centralized coin that can be distributed to users. However, these approaches do not determine a value generated by the data, and therefore do not provide the users with a reward that is commiserate with such value.

The present embodiments provide an approach for secure exchange of data for cryptocurrency by providing a platform whereby providing data can be exchanged for such coins.

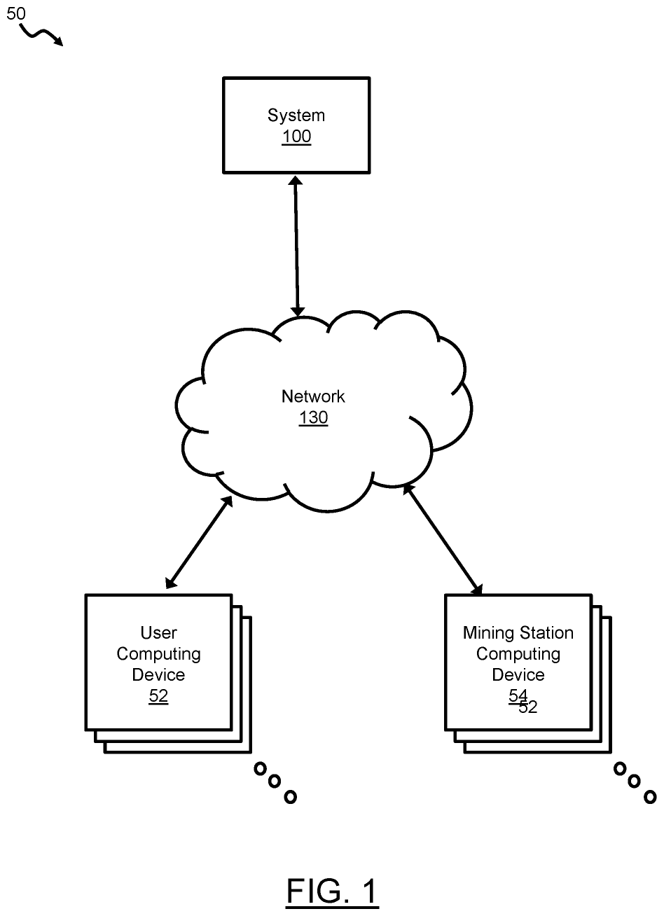

Referring now to FIG. 1, a diagram of a computing environment 50 is shown for a system 100 for generating contracts for secure exchange of data for cryptocurrency. The computing environment 50 includes a system 100, as described herein, operating on one or more computing devices, one or more users operating on computing devices 52, and one or more mining stations operating on computing devices 54, all communicating over a network 54 (for example, a local area network or the Internet). The computing devices can be any suitable device; for example, a server, a desktop computer, a laptop computer, a smartphone, a tablet computer, a mobile device, a smartwatch, or the like. In other cases, aspects or functions of the system 100 can be run on further computing devices, such as a separate server. In some embodiments, the components of the system 100 can be executed on one or multiple computing devices or otherwise having the functions performed by the system 100 distributed among two or more computing devices that may be locally or remotely distributed. While the present embodiments may refer to users 52 and mining stations 54, it is understood that this is in reference to the computing devices of such entities, and the actions of such entities are instructions executed on the respective computing devices.

The system 100 enables users to enter into an agreement with a service provider to be rewarded with digital cryptocurrency in exchange for their time, attention, and/or data. The system 100 is responsible for enabling mining and setting the mining rules between the users 52 and the mining stations 54.

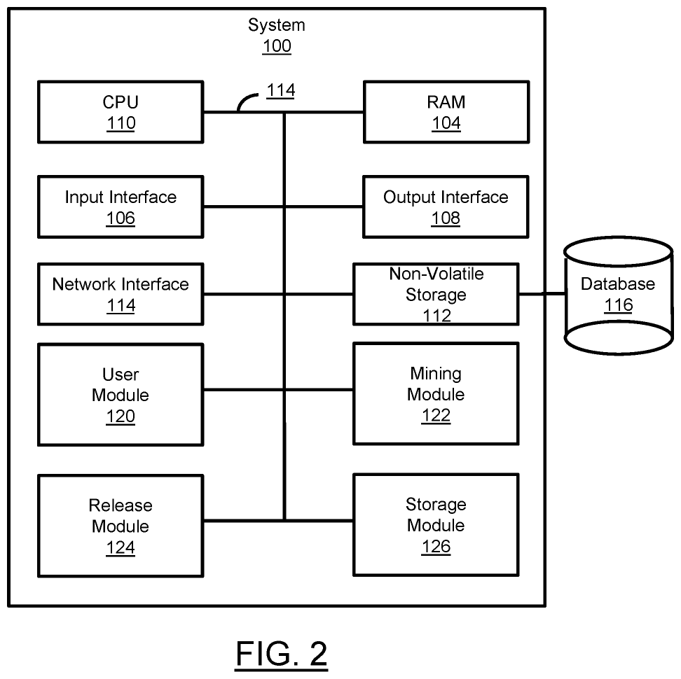

FIG. 2 shows a diagram of the system 100 including various physical and logical components. As shown, the system 100 has a number of physical and logical components, including a central processing unit (“CPU”) 110 (comprising one or more processors), random access memory (“RAM”) 104, an input interface 106, an output interface 108, a network interface 114, non-volatile storage 112, and a local bus 114 enabling CPU 110 to communicate with the other components. CPU 110 executes an operating system, and various modules, as described below in greater detail. RAM 104 provides relatively responsive volatile storage to CPU 110. The input interface 106 enables an administrator or user to provide input via an input device, for example a keyboard and mouse. The output interface 108 outputs information to output devices, such as a display and/or speakers. The network interface 114 permits communication with other systems, such as other computing devices 52 over the network 130. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution. In an embodiment, the system 100 further includes a number of conceptual modules, including a user module 120, a mining module 122, a release module 124, and a storage module 126. In some cases, the modules 120, 122, 124, 126 can be executed on the CPU 110. In further cases, some of the functions of the modules 120, 122, 124, 126 can be executed on a server, on cloud computing resources, or other computing devices 52. In some cases, some or all of the functions of any of the modules 120, 122, 124, 126 can be run on other modules.

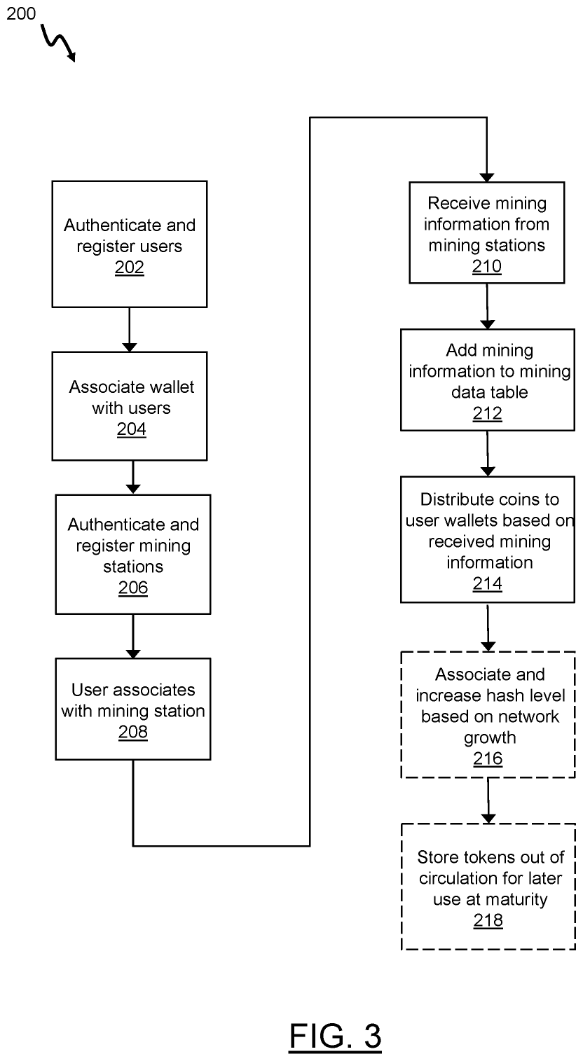

FIG. 3 illustrates a flowchart diagram of a method 200 for secure exchange of user interactions for cryptocurrency, in accordance with an embodiment. At block 202, the user module 120 authenticates each user 52, ensuring that users who want to mine are real, using know-your-client (KYC), SMS (Short Message Service) authentication, or any other suitable authentication approach.

At block 204, the user module 120 associates a user wallet identification (ID) for each user 52 to allocate currency mined to such users 52 and enable users to be found by the system 100 as users 52 associate with various different mining stations 54. The user wallet can be located on the system 100 or on the user computing device 52.

At block 206, the user module 120 authenticates mining stations 54 using any suitable authentication approach. In some cases, platform contracts can be used to ensure mining stations 54 agree on sharing revenue with users 52. Depending on the mining stations 54, different mining approaches are coded in such platform contracts. Mining approaches can take various forms as suitable. In non-limiting examples, mining by the user 52 for a mining station 54 that is a game app can include by playing the game. Mining for a social media platform can include adding posts or connecting with others. Mining in a blog can include time spent on the blog without performing any action. In this way, mining is can be any activity or data (i.e., user interaction) that can add value to the mining station 54 and allows value to be shared with the user 52. In some cases, the platform contracts can be registered on the blockchain to ensure responsibilities are met.

At block 208, the user module 120 receives indication that a specific user 52 has associated, used, or joined one of the mining stations 54. To associate with the mining station 54, the users 52 input or otherwise associate their wallet ID with the mining station 54. Such association can be done at login or registration.

At block 210, when users 52 are associated with respective mining stations 54, the mining module 122 receives indication from the mining station 54, for example via an API (application programming interface) connection, that the user 52 is mining; where such mining is by the user providing their associated user interactions (for example, time spent or data provided).

At block 212, after receiving user mining information from mining stations, the mining module 122 adds mining data into a mining data table, for a smart contract, to read and unlock cryptocurrency coins from a blockchain. The mining data table includes mining information data performed at various mining stations and the users associated with such mining information.

In some cases, a POI (proof of interaction) can be used for determining users' 52 mining actions. POI can be run by the mining module 122 and, in some cases, by the mining stations 54. In some cases, at the mining stations 54, the POI determines specific actions that are custom-coded for each mining station according to the platform contract to be associated mining user interactions. Such interactions are decided and established based on mining stations services offered to users, and can be custom the mining station. In an example, in a game application, such user interactions can include how long the users are playing the game, how many times the user plays the game per day, the levels that are achieved by the user playing the game, and the like. In another example, in a social media platform, such user interactions can include posts added by the user, what kind of posts are added, the influence of the user, the number of contacts/followers of the user, and the like.

At block 214, the release module 124 distributes cryptocurrency coins to wallets associated with user 52 based on the mining information. In some cases, the release module 124 can have a centralized wallet. Once cryptocurrency coins are released from the blockchain, they are stored in the centralized wallet. Then, the coins to be distributed to users 52 are distributed from coins stored in this centralized wallet. The cryptocurrency coins received by each user 52 in their wallet can then be exchanged on any suitable cryptocurrency exchange. Unlike other blockchains that are coded to distribute coins per block created, the present approach distributes coins to each user at a specified period (for example, once daily) and distributed under the terms of the smart contract.

The smart contract can be used to lock the coins and secure the cons inside the blockchain. The release module 124 can read the mining data table and match data stored in the mining data table with instructions written in the smart contract. In a particular case, the release module 124 can read the data on the mining data table, matches it with the data available in the smart contract and distributes coins to the internal server wallet for distribution. After the smart contract is used to transfer mined coins, the smart contract gets deactivated until it is set to read the mining data table again. The information available on the smart contract can be publicly available through the blockchain and can be accessed and audited by anyone without restriction, ensuring that even though the mining and the blockchain is decentralized.

Any suitable blockchain can be used. In an example, a fork of the Ethereum blockchain can be used.

In some cases, the release module 124 can not only distribute coins based on the users' mining activities, but also a daily allotment of coins based on remaining users that are participating.

Advantageously, the present embodiments can enable a mining approach that allows any abstract commodity to be turned into a digital asset by converting it into a cryptocurrency. In this way, new cryptocurrency coins are mined through the conversion of user interactions into such coins.

In some cases, once the blockchain is fully matured, such as after a predetermined number of transactions have been completed, third-party miners can use computing power to authenticate the blockchain, using nay suitable Proof of Authority approach. At maturity, viable compensation can be offered through transaction fees.

In some cases, at block 216, the release module 124 can associate a base level hash power with each authenticated user 52 and increases such hash power of the user 52 based on their efforts to grow the network. Upon registration and authentication of each member, the user module 120 assigns each user 52 a referral code. The referral code is used to identify the referrer user 52. In an example, the referrer gets rewarded with an increase in hash power for every two new users authenticated and registered with their referral code. The hash power can effectively act as a multiplier for the amount of coins released to a user under the smart contract.

In some cases, at block 218, the storage module 126 can store coins taken out of circulation when such coins have been used by mining stations 54; which can be under the terms of a secondary-type of smart contract. Coins are taken out of circulation to control inflation as users constantly mine new coins based on their interaction with the mining stations 54. This also retains value-added by such interactions. In some cases, when coins in the centralized wallet of the mining module 122 are depleted, coins stored by the storage module 126 can be used; in such cases, these coins, that were previously taken out of circulation, will become available for mining as if they were new coins newly minted. However, at maturity, generally the quantities of coins distributed for mining from the storage module 126 will be predetermined fractions of the coins.

For plain language on the technical explanation of the ecosystem described on FIG. 3 please consider the additional text enclosed in this paragraph:

We make the following technical changes in blockchain technology to convert cookie data, user interactions or any abstract asset into a digital transferable asset —cryptocurrency.

To do that, we create a DAO (Decentralized autonomous organization) and a Central server (NEEbytes server).

The central server is responsible for enabling mining and setting the mining rules between the people and the mining stations.

The Server

### For People:

The server ensures that people who want to mine are real by authenticating them through KYC, SMS, or any other method that seems fit to confirm users are not bots or have opened multiple accounts.

After users authentication is done, the server assigns a wallet ID and login credentials to each user.

Wallets IDs are used to allocate currency mined to users and enable users to be found by the server as users join different mining stations.

To join mining stations, users will have to add their ID in a profile field made available by mining stations, or users will have to log into mining stations using NEEbytes credentials. Credentials are also generated upon users' authentication by the central server.

When users log inside mining stations, the user ID gets activated by a set of algorithms deployed inside mining stations. The algorithms inform the serves through API connection between server and mining stations that the users are mining.

After receiving user mining information from mining stations, the central server will add mining data into data table #1 for DAO (smart contract) to read and unlock coins from the blockchain.

Data table #1 will hold all mining information performed in various mining stations until DAO unlocks coins from the blockchain, sends them to the server's internal wallet, and the server distributes coins to members' individual wallets based on their mining activities.

### For Mining Stations:

The central server will authenticate mining stations and create contracts to ensure mining stations abide by the protocol and agree on sharing revenue with users.

Depending on the platform (mining stations), different mining methods will be coded to cater to their specific and different needs.

Mining can be done in various forms. For instance, mining can happen in a game app by playing the game. If in a social media platform, mining can be done by adding posts or simply by connecting with people. For blogs, mining can be done by the time spent inside such a platform as users will take time to read but won't need to perform any action. (Mining is done in any way that can add value to the mining station and is enabled to ensure value is shared with the user)

Online platforms (data-consuming entities), upon registration with the server, must agree to terms and conditions in a formal contract that later is registered into the blockchain to ensure responsibilities are met in order for them to become mining stations.

Some of these responsibilities are to ensure users can log in and add their NEEbytes user ID inside such mining stations. Alternatively, the mining station can enable ID activation by allowing neebytes users to log in using NEEbytes credentials.

To become a mining station, such entities must ensure all algorithms, tags, and codes made available by the NEEbytes server are in place and ready to establish the connection between both (the server and mining station).

The connection between mining stations and the server is made through an API.

The API connection ensures that all communication done through algorithms is possible and transmitted to the NEEbytes server.

THE DAO (Decentralized Autonomous Organization)

### The Smart Contract (DAO)

DAO is written to lock the coins and secure the cons inside the blockchain.

The DAO is responsible for reading the central server data table #1 and matching data stored in data table #1 with instructions written in the DAO (smart contract).

Instructions on what to read inside the central server are stipulated when the DAO contract is created.

DAO reads the data on data table #1 daily, matches it with the data available in the smart contract and distributes coins to the internal server wallet.

After the DAO has transferred mined coins, DAO gets deactivated until it is set to read the server data table #1 again.

The information available on the DAO (smart contract) is publicly available through the blockchain and can be accessed and audited by anyone without restriction, ensuring that even tho the mining method of the blockchain has changed, the blockchain is still decentralized.

NEEbytes have used the Ethereum blockchain but forked it to implement the additional changes described above. The changes have been implemented to enable a new mining method that allows any abstract commodity to be turned into a digital asset by converting it into a cryptocurrency.

Below are the steps necessary for the activations of the ecosystem.

### 1. User

The user creates an account on the server
Users get authenticated by KYC or SMS
The user receives login credentials, server ID, and Wallet ID

### 2. Mining Stations

Mining Station creates an account with the server
Authenticate themselves through KYC
Agree with terms and conditions and sign a contract abiding by the NEE blockchain protocols
Mining codes and algorithms are created to fit mining station features
The online platform receives the title of the mining station
The mining station connects with the server through API
Algorithms, codes and tags are deployed to enable the server to read users mining actions

### 3. Mining Process

Users login to the mining station.
Users add their ID into the mining station or login using NEEbytes credentials.
Mining station Proof-of-interaction algorithms (PoI) activate users' IDs and inform the server every time users log in.
Algorithms read users mining actions and communicate them to the servers through an API
The PoI on the server stores actions performed by users together with the coins mined history, inside data table #1
DAO Interacts with Server Daily to Read Data Store on Data Table #1
DAO confirm data matches with the DAO smart contract and transfer coins mined to the server
Servers receive coins mined to the internal server wallet
The server distributes coins mined to each users wallet as per data stored in data table #1
Server clear data table #1 after coins are distributed and after data is transferred to the data table #2

To better explain and differentiate the algorithms I have described in the NEEbytes blockchain ecosystem, I have given them names like other blockchains.

For NEEbytes blockchain to work and achieve its purpose, three consensus algorithms are necessary and have been implemented.

PoA—Proof of Authority (already existing in other blockchains) has been implemented in NEEbytes blockchain to prevent hacking.

Traditional miners are compensated with newly minted coins in existing blockchains, but this is not the case in the NEEbytes blockchain since newly minted coins are mined through the conversion of data into coins (digital assets).

Because the NEEbytes mining method has been changed, miners have no incentives to use computer power to authenticate the blockchain, so PoA has been implemented to ensure such mining feature is only enabled when blockchain is fully matured, and viable compensation can be offered through the transaction fees.

The following has been added to the existing blockchain technology to enable the new mining method where data is converted into NEEbytes:
One server

1 Two Smart Contracts—Decentralized Autonomous Organization DAO1 and DAO2 Two data tables, DT1 and DT2
Three algorithms:
One already mentioned above, Proof of Authority (PoA) consensus,
Two new algorithms that were created for the NEEbytes blockchain ecosystem,
Proof of Efforts (PoE) and Proof of Interaction (PoI)

The above permits a new mining method, where an abstract commodity is symbolically tumed into a digital asset.
It creates an economy for the ecosystem.
It controls inflation and ensures the continued supply of the currency.

### The Server

Distributes currency
Stores users wallets
Authenticate users

The server distributes the currency mined to users by following the consensus of Poe and Poi algorithms. (Poe and Poi are the new algorithms created for NEEbytes blockchain)

Unlike traditional blockchains coded to distribute coins per block created, NEEbytes blockchain distributes coins once daily. In the Neebytes blockchain ecosystem, coins are distributed through a smart contract called DAO.

In NEEbytes, blockchain coins are mined in 2 ways and mining is governed by two algorithms, described below:
A daily block of coins is distributed to members based on Proof-of-Efforts (Poe) and Proof-of-Interaction (Poi) algorithms.
To mine the daily block, users must mine the DAO itself before.
To mine the smart contract—DAO users must interact with mining stations and activate the PoI consensus algorithm.

PoI (Proof of interaction) algorithm is responsible for reading users' mining actions.

PoI algorithms run inside the server and mining stations.

Inside the server, Poi algorithms receive mining confirmation from mining stations and store it inside data table #1.

Inside mining stations, Poi monitors users' mining actions saves it inside DT1, inside the server.

PoI algorithms send mining data through an API connection to establish communications between server and mining station.

PoI is code to remain dormant inside the mining station. It only activates when a user, using NEEbytes ID or credentials, logs in inside mining stations, activating PoI to read mining actions.

The PoI consensus installed inside mining stations is customized with a branch of codes that can only read specific actions that are custom-coded for each mining station differently.

Such mining actions are decided and established based on mining stations services offered to users.

The branches of the PoI algorithm could be coded to read different actions.

For example,

For game app:
How long the users are playing the game.
How many times user plays the game per day. Levels that are achieved as users play the game.

For a social media platform:
Post added by users.
What kind of posts are added. How influential users are.
How many friends the user has.

Independently of what kind of actions the coded branches added into PoI can read inside mining stations, the core function coded into the PoI does not change, and it is:
Activate itself when the user logs in with NEEbytes ID or by using NEEbytes credentials.
Read mining actions inside mining stations (online Platforms).
Send mining data collected inside mining stations to the server.
Store mining data inside the server in “data table #1—(DT1). Activate user PoE consensus to enable users' daily block mining.

Proof of Efforts (PoE) Algorithm

The proof of efforts (PoE) algorithm is created to award the community for their efforts in helping grow the community.

PoE is responsible for increasing members' hash power based on their efforts to grow the network.
Upon registration and authentication of each member, PoE algorithms assign the member a referral coder.
The referral code is used to identify the referrer.
The referrer gets rewarded with one hash power for every two new members authenticated and registered with their referral code.

The PoI algorithms activate each user's hash power every time the user performs a mining action inside a mining station.

The PoI algorithm stores mining actions together with the hash power information of each user in DT1.

When hash power is activated, it is used to mine the daily block of coins. The daily block is released by the DAO and distributed by the server. Distribution happens based on the information stored in. that Information in DT1 is added by PoI algorithm consensus.

The Smart Contract—DAO

The DAO is coded to run daily. It reads the DT1 stored inside the server for matching conditions written in DAO, that if met, will activate the release of coins to the internal server wallet.

The server will then follow instructions on DT1 and distribute coins mined to the appropriate members.

In the NEEbytes blockchain, we are able to convert abstract commodities into digital assets because mined coins are not distributed straight from the blockchain to users' wallets. Still, instead, blockchain coins are deposited into the DAO, DAO transfers the coins to the server, and the server deposits the coins to users' wallets, based on data added into DT1 as per PoE and PoI algorithms that were put in place.

The DAO is coded to match conditions with DT1, and if conditions are met, then distribute coins to the server.

With the help of PoI and PoE algorithms DAO enables 2 methods of mining:

DAO distributes a pool of coins, delivered daily and deposited as a block of coins into the server's internal wallet so that the server can distribute coins to members based on their efforts and interactions with the platform, read by PoE and PoI algorithms.

Every night the DAO deposits the pool (block) of coins plus the additional coins mined from it by PoI consensus to the NEEbytes server-internal wallet. The server then distributes it accordingly to data stored in DT1.

In the NEEbytes ecosystem, coins are not only mined from the block automatically distributed daily by the DAO. Extra coins are also mined directly from the DAO based on users' interactions with mining stations that are read by the PoI algorithms put in place, which later add the mining data into DT1.

Avoiding Inflation, Retaining Value and Promoting the Continued Existence of the Ecosystem With DAO2

DAO2 is responsible for storing coins taken out of circulation when used for revenue sharing by mining stations.

Coins are taken out of circulation to control inflation as users constantly mine new coins based on their interaction with the ecosystem through the PoI consensus algorithm.

This also retains value-added by revenue sharing and keeps it in the ecosystem.

DAO2 also has been coded to ensure the ecosystem does not stop when coins are depleted from DAO1.

When DAO1 coins are depleted, DAO2 takes its place. Coins inside DAO2 that were taken out of circulation will become available for mining, just as if they were new coins newly minted.

The difference is that when the ecosystem matures and DAO2 takes the place of DAO1, the quantities of coins distributed for mining will be just fractions of what was once released by DAO1.

I hope the additional description of the ecosystem described above in this paragraph 58, will be of help for a better understanding of the system created.

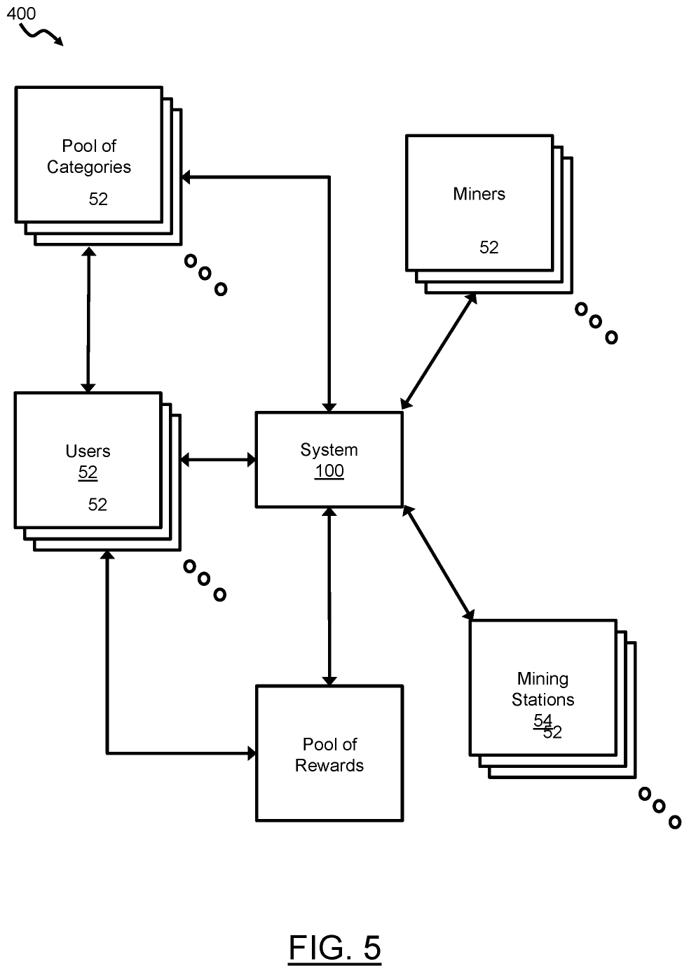

In another embodiment, FIG. 5 illustrates an example conceptual diagram 400 illustrating interactions between the system 100, users, mining stations, and miners, including their connections with the pool of rewards and pool of categories, as described herein.

At block 302, the user module 120 registers and authenticates new users (each operating on computing device(s) 52) by, for example, receiving identifying information for the user. Any suitable identifying information can be used, for example, a name, address, picture, pseudonym, bank account, or the like. The identifying information is generally intended to prevent single users from signing up with multiple accounts. The user module 120 associates an identification number (“ID #”) and cryptocurrency wallet for the registered user. The cryptocurrency wallet is a conceptual storer for cryptocurrency coins associated with the user. In some cases, the user can receive a coin for registering, as a reward for providing the identifying information. While the present embodiments contemplate a new cryptocurrency coin, in further embodiments, any suitable cryptocurrency coin or value-storage-unit can be used. While the present embodiments and disclosure may refer to releasing and purchasing of cryptocurrency ‘coins’, it is understood that ‘coin’ in this context can refer to any suitable denominations or coin values, including fractions of coins.

At block 304, the mining module 122 associates data with each registered user. In some cases, associating the data can include collecting the data itself. In other cases, associating the data can include receiving indexes associated with data collected by the data-collecting entity but not yet accessed by such entity. For example, data logging through receiving Hypertext Transfer Protocol (HTTP) cookies that log user activity as the user browses the Internet or uses online services. For each day that the mining module 122 collects data about the user, the mining module 122 instructs the release module 124 of such data collection.

At block 305, the release module 124 generates data contracts with the mining station 54 after such entity provides coins. The release module 124 then sends the data contract to third-party miners to be added to the blockchain, as described herein.

At block 306, the release module 124 releases a predetermined quantity of coins to the user's cryptocurrency wallet. In some cases, this can be accomplished via the implementation of a smart contract, whereby the release of coins is halted if the user leaves the platform or otherwise stops sharing the data. Blocks 304 and 306 are repeated for each user.

In some cases, the amount of coins provided to each user can be predetermined by the release module 124, if such coins are newly generated. In other cases, where the users are receiving coins due to a contract with consuming entities, the amount of coins will be based on the value of that data purchased in the contract, which is added into the pool of rewards, and sent to users that are registered under said pool.

In some cases, the quantity of coins released to a given user's cryptocurrency wallet can be based on the types and/or categories of data shared by such user, and/or the amount of identifying information provided. For example, the user can be provided with more coins for providing name, address, and occupation information over someone who just provides their name. In another example, a user can accept to have Internet browser cookies added by consuming entities in the user's browser for a daily coin return. In some cases, the data is only collected for certain websites and/or services provided by consuming entities, and thus, the coins are only released to the user if they use such websites and/or services. In some cases, the user can explicitly agree to receive advertising information, such as with a push notification on their smartphone, or agree to answer a survey, to receive extra coins. In some cases, on a per-category basis, the user will be appraised of what information will be collected and the user can decide if he/she agrees to the collection of such category of data. In some cases, the quantity of coins released to a given user's cryptocurrency wallet can be based on other metrics; for example, the amount of time spent on a content provider's webpage or the number of advertisements presented to the user.

At block 308, the mining station 54 purchases coins from the blockchain from the release module 124 in order to purchase data contracts. This quantity of coins will be useable by the mining station 54 to exchange for users' data. Thus, the number of coins purchased is correlated with the amount of data the mining station 54 wishes to procure.

At block 310, the mining station 54 communicates with the release module 124 that it would like to procure some of the collected data, upon entity request the release module 124 will organize data contracts for the requested collected data and will generate a digital invoice to paid by the consuming entity. In an example, the data contracts can comprise the user's ID and a date range over which time the mining station 54 can use or access the user's data; in some cases, then allowing the mining station 54 to extract the user's associated data on the mining station 54's own system and/or services for such period. The digital invoice can be used to add the transaction to a blockchain, as described herein, to prove that the mining stations had rightfully purchased the user's data and allows for audits at a later point in time. The mining station 54 can be any suitable company or entity; for example, a search provider, a social media platform, an advertiser, or the like. In some cases, the mining station 54 can be required to be registered and/or recognized by a governmental privacy agency or a privacy union or association prior to being able to purchase contracts. In some cases, the mining station 54 can indicate which types or categories of data it would like to procure and how many users worth of data it would like the package of data to encompass. The mining station 54 then purchases the necessary amount of coins with the release module 124 after the release module 124 issues the invoice. Once the invoice payment is authenticated by the blockchain, the release module 124 forwards the data contracts or otherwise notifies the consuming entity of the ability to access the data as per the data contracts that the consuming entity had purchased. In some cases, such package can be certain users that provided data in a certain category, or otherwise data from certain users that have been filtered from their identifying information. In some cases, the data can be time-limited, in that the data will be deleted upon an expiration date; whereby the expiration date can be correlated with the amount of coins provided for such data.

At block 312, the release module 124 distributes the coins provided by the mining station 54 equally to all users who provided data in the type and/or category that was procured by the mining station 54 in the exchange, allocating those coins into the pool of rewards, in block 310. In this way, those users receive the coins used to purchase the data contracts, in some cases, in addition to a daily allotment of coins. In this way, the split of coins are based on a mathematical calculation, the more the user participates, the more coins they receive as a reward.

In an example, in a scenario where two users have each received 100 surveys and first user responds to only one survey and the second user responds to one-hundred surveys, there are a total of 101 surveys answered. The first user will receive a share of 0.99% of the coins introduced into the pool of rewards by the data-collecting entity for responding the survey (1/101=0.0099*100=0.99%) and the second user will receive a share of 99% of the coins (100/101=0.99*100=99%).

At block 314, a user can communicate with the release module 124 to exchange coins in their wallet for a monetary value. In some cases, a branch to the blockchain is added with every registered wallet. In some cases, every time such wallet needs to transfer funds, the release module 124 send a message to the user, such as to the user's smartphone or computer system detailed in the identifying information. The message includes a PIN code (such as with 2-factor authentication) which the user can provide back to the release module 124 when exchanging the coins for the monetary value. This ensures that the user in authorized to withdraw the funds.

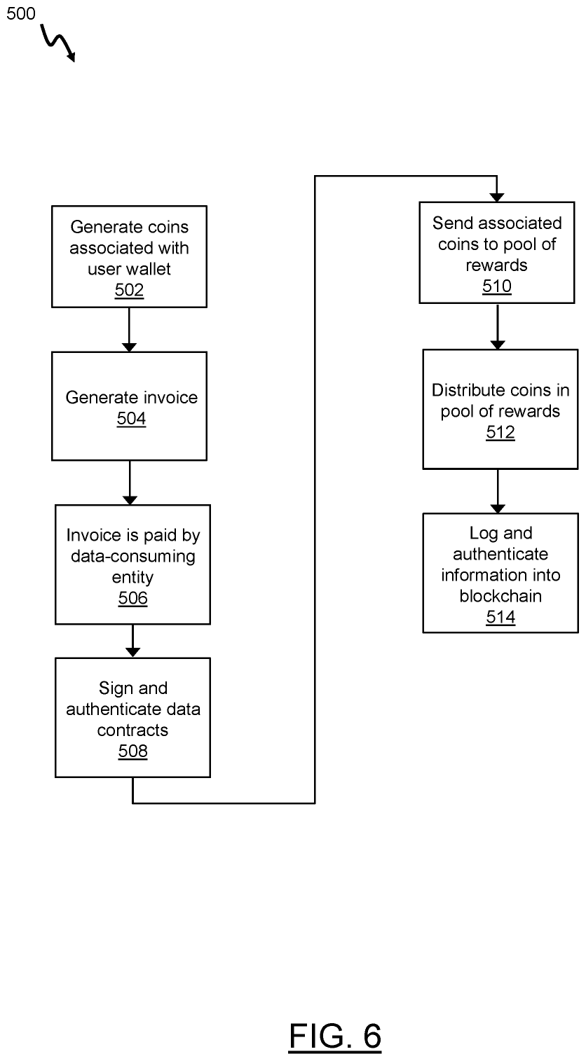

Advantageously, as illustrated in FIG. 6, the embodiment embodied by the method 300 uses a method of exchanging smart contracts 500 to execute the exchange of data for coins. After the user registers and is authenticated, the system 100 represents the user's interests with respect to their data. For each selected category that the user registers under, at block 502, the system 100 instructs the third-party miners to generate a certain number of coins which are associated with the user's wallet. New coins created by the blockchain are distributed between users, whereby the system 100 allocates extra coins to users based on the pool of categories. Where a mining station 54 negotiates a data contract purchase with the release module 124, the release module 124 generates an invoice at block 504. The mining station 54 pays the invoice to the release module 124 at block 506, and the release module 124 signs and authenticates data contracts on behalf of users at block 508. The release module 124, at block 510, then sends the associated coins to the pool of rewards associated with the appropriate category. Where after receiving coins due to data contract purchases, the release module 124, at block 512, distributes the coins in the pool of rewards between users in the appropriate category. Where the system 100 registers the data contracts and user's IDs to be authenticated, at block 514, the miners log and authenticate the information provided by the release module 124 into the blockchain.

The cryptocurrency wallets associated with the users are added to the blockchain by the user module 120. This provides an extra lair of security over other blockchain protocols. In other blockchain implementations, if a user loses both wallet keys (public key and private key), the user loses all their assets. In contrast, the user module 120 can add the wallet to the blockchain and use two-factor authentication to retrieve users' passwords/assets.

In some cases, the mining station 54 can use the ID #to locate users using their own platform or services; for example, companies that need third-party cookies access can add an option for users of their platform or services to enter, and thus associate, their ID #with their platform profile.

The release module 124 records the transaction on a blockchain with mining station 54's name and purchase recorded on the blockchain. Advantageously, this record can be used to avoid unknown breaches of privacy, and allows the data exchange and the consuming entity to be audited in the future.

In most cases, the release module 124 can act as an intermediary (i.e., bridge) with the mining stations purchasing the coins from users willing to sell their coins. In order to buy data contracts, the consuming entities can purchase coins through the release module 124, where coins on the open market can only be purchased for investment or remittance; in this way, the release module 124 ensures that the market is free of monopoly and provides it with a higher liquidity.

In some cases, with respect to surveys, the mining stations can add their own questions to a survey given to the user each day, at a predetermined cost to access survey answers.

Advantageously, the mining stations who would like to track behavior of the users can effectively purchase the rights to such data based on the daily value; by purchasing the users data contracts issued and logged into the blockchain for later audits. For example, data can equal 0.001 coins per category per day, thus, if the entity desires a year's worth of data for 100 users to track their costumer behavior, they will need to purchase 3.65 in coins (100×0.001×365) purchased through the release module 124.

Generally, the value of the coins in real currency will depend on market forces (i.e., determined by supply and demand of the coins). Advantageously, this will enable the system 100, its users, and its mining stations to determine the value to the commodity (data) in real terms based on a union like ecosystem. In an example, one can arbitrarily fix a value to a single person's full-year's worth of data to be one coin. However, if the market forces appreciate the value of the coin, for example to tenfold, then the mining stations may not be interested in purchasing data at such a high price. Instead of a fixed value, a union environment, with representatives of users and mining stations, can be created where a fair price can be negotiated and agreed upon by the various stakeholders. Potentially valuing data at fractions of a coin instead of at full coin denominations.

Advantageously, the system 100 can act as an automated agent relationship with its members, connecting both ends of the transaction the buyers (the consuming entities) and the sellers (the users). Advantageously, the system 100 enables the users and the consuming entities to have a secure method of exchange of data for monetization, enabling an ecosystem that abides by privacy regulations requiring stricter privacy guarantees for consent. Additionally, the system 100 provides an operating environment that can track transactions in the blockchain, such as who purchased and who authorized the procurement of such data.

In the present embodiments, mining can include performing native activities at the respective third-party miners, which consume data to display advertisements. In most cases, third-party miners can be authenticated before being approved for mining to prevent bad actors and/or bots from opening multiple accounts. As third-party miners and users 52 become authenticated, they can receive an internal ID #associated with a respective wallet. The ID #, instead of other identifying information, can be used to ensure privacy and prevent discrimination. In some cases, the system 100, or another central server, can retain the data pertaining to the registrants and centralized wallets to ensure integrity is kept and appropriate information is made available to the third-party miners. In some cases, connection with the system 100 or other central server can be made through API connections.

Advantageously, mining is effectively completed by performing native activities available inside of a publisher's platform; for example, reading webpages, playing games, adding posts, and the like. In this way, each user adds value in their interaction with the publisher by watching advertisements or contributing content, and in this way has the ability to monetize such activities.

In some cases, data can be siloed such that it is not shared across platforms. Instead, such data is only located at the third-party miners that store it. Only actions performed at the third-party miner, for example, based on a mining agreement, are communicated to the system 100 to prompt coin distribution.

The present embodiments provide an approach where data is a medium of exchange. The use of the present technological solution allows publishers to reward their users without incurring high remittance and payroll fees, where these costs would make rewarding users near impractical without the technology of the present embodiments. In some cases, the system 100 can track users' actions across third-party miners (online platforms).

In some cases, implementations of the present embodiments can have one or more of the following properties:
A relative decrease in hash difficulty can be selected as compared to other implementations to enable faster transactions.
Transactions fees can be set relatively low to offset the cost of many transactions per day as coins would have to be distributed to users daily.
The speed of blocks can be selected to a low value (e.g., 5 seconds) to enable more transactions per second.

The above properties can be selected to ensure that the aspects of the present embodiments can be used by many users without overly limiting restrictions.

In some cases, to combat inflation and monopolization, implementations of the present embodiments can have one or more of the following properties:
Coin creation can be capped, for example, at 11 Billion coins.
A certain percentage of coins mined (e.g., 10%) can be held in a central treasury.
To avoid fake values from being added, coins can only be mined by the users whose activity results in mining.
Value can be added to mined coins when traded on an exchanges.
All miners can be considered equal and have the same amount of coins available to be mined daily by each user.

In some cases, instead of coins being assigned to the blockchain by block creation, all unmined coins can be locked inside a central wallet associated with the system 100, and this wallet can be openly monitored by the community. The central wallet can be responsible for transferring the cryptocurrency coins to the miner as new coins are mined. As the system 100 receives the information of coins that are mined, such as through an API connection, the system 100 can distribute accordingly to the respective miner's centralized wallet. The miner can then withdraw their coins to an external wallet. An address of the central wallet can be made public for anyone to follow and thus audit the wallet. In some cases, coins that are mined can also be made public, so that any entity can audit the blockchain if desired.

In some cases, a smart contract can be used to prevent and control inflation. The smart contract can be responsible for destroying coins purchased for profit-sharing. Organizations can send coins to be registered inside the blockchain and coins can then be taken out of circulation.

In further cases, coins can also be destroyed after the coins are used to allocate profit to the users.

In some cases, PoA (Proof of Authority) consensus can be used to ensure the integrity of the blockchain is under control over time, preventing potential attacks.

In some embodiments, since blockchains have a capacity, a number of transactions per second (TPS), and the capacity is typically limited (anywhere from 1 to 1000 TPS—even with the maximum amount of transaction (1000 TPS) by the end of the day (24 hrs.) only 86.4 million transactions would be processed. In some cases, this is dearly far from being able to cater to the demand of some audiences of internet users; some platforms have billions of users. In this way, existing blockchains would have trouble keeping up with such demand due to such blockchains typically limiting the number of transactions per second (TPS); due to the data size of each transaction holds and the size of each block that can hold so much data at a time.

Block size and number of transactions get combined and added and get sent to be calculated by miners. Blockchains are run by nodes/third-party miners. Nodes have a preset time to find the next block based on the coding of each blockchain (creating a new block means finding a number that needs to match the previous block). Each node needs to process the whole data inside the blockchain in its entirety until it finds the next block. Once a node finds the block first (by finding the result of a calculation that matched the previous block), the node starts to work on the next block, so do all the other nodes. Whoever finds the next block first, gets awarded with cryptocurrency coins. The cryptocurrency coins are generated by the blockchain protocol, and since all nodes works decentralized but under the same protocol. In some cases, a plurality of confirmations of a block (such as at least 5) can be used in case of fake blocks trying to be added to the blockchain. However, while this approach is secure, it adds an excessive amount of unnecessary data into the new blocks, making the blockchain overloaded with unnecessary data that adds into the scalability issue; holding blockchains back in its capacity to process fast TPS.

The blockchain implemented in the present environment 50 advantageously uses necessary data for a secure method of transactions authentication, with the ability to store contract data and deploy smart contracts. In this way, the third-party miners can authenticate blocks in a much faster way, preserving security features of typical blockchains while also adding more security and scalability (with the wallet and nodes protocol described herein).

In an example of the present environment 50, the amount of data stored in blockchain blocks is limited by some factor, such as by number of days or number of actual blocks. This means more space is available on blocks for more transactions. Cryptocurrency coins, instead of being generated by blocks, will be generated at a certain rate per day or other timeframe. Thus, providing rewards for the nodes instead of being based on coins generated by the chain. This reward can be based on transactions fees that are generated by the blockchain. Nodes will receive transactions to add into the blockchain and then find new blocks. Blocks will be timed to the lowest time frame possible, but nodes, instead of dealing with hash difficulty, work to find the next block first. Nodes will have little, or no, hash difficulty on the blockchain; enabling all nodes to find blocks extremely fast and without computational difficulty. Blocks will have to be found in a preset stipulated time. When a node finds the next block, the blockchain protocol will freeze that same node and will add that node in a time loop; that applies to all consecutive nodes that finds the block result within the stipulate block time frame. Once a majority, or all nodes, have found the same block within the time frame, the protocol will add the block into the blockchain, creating the longest chain by nodes consensus; avoiding extra chains to be dropped along the way and overload new blocks with data. Once such nodes find the next block, the protocol takes nodes that are still processing in the time loop, out of such time loop, and delivers new transactions to be added in the blockchain. This is repeated for each block. In the case of a node that cannot find a block result within the specific amount of set time per blocks, nodes will be stopped by a time out timer and will receive new transactions to start again with the new calculation to find the next block. Advantageously, this approach also facilitates spotting an attack against the blockchain, since all nodes need to come back with same result. If nodes constantly deliver wrong block results, it can be flushed out by the system 100 or generally by the protocol. Advantageously, this approach also helps to prevent against a 51% attack.

Advantageously, the present embodiments enable any platform that uses users' data to incorporate miners, and thus, automatically convert users' data, time, and attention into cryptocurrency. In some cases, content providers who become miners can offer their users as much profit as they like in exchange for the users' data.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for connecting companies in need of data with individuals seeking to monetize data or other abstract commodities, comprising:
a. Authenticating users within the platform;
b. Providing the option for users to produce and share data within the platform or with a mining station connected to the platform via API or another method of connection;
c. Allowing users to directly add data to the platform by creating and answering surveys or collecting data gathered through the platform;
d. Storing the data securely within the platform for future access or potential sale;
e. Converting generated data into the platform's native cryptocurrency asset when required;
f. Holding the data in a marketplace-like ecosystem, enabling users to access or sell the data;
g. Distributing cryptocurrency coins to users in exchange for providing data;
h. Requiring companies to purchase cryptocurrency coins from users through a crypto exchange/open market to access the data;
i. Controlling inflation by removing purchased coins from circulation and reintroducing them when all coins are mined, thereby supporting the new economy and ecosystem backed by data as the currency.

2. The method of claim 1, wherein the platform offers users the ability to choose whether to produce and share data within the platform or with mining stations, providing users with control over their data sharing.

3. The method of claim 1, wherein the platform facilitates the creation and answering of surveys to collect data directly from users, enabling users to participate in data generation.

4. The method of claim 1, wherein the platform ensures the security and privacy of user data by anonymizing and associating data with an internal ID and then converting data into the platform's native cryptocurrency asset before storing it.

5. The method of claim 1, wherein the platform acts as a secure marketplace, holding and managing user-generated data for potential future buyers.

6. The method of claim 1, wherein the distribution of cryptocurrency coins to users incentivizes data generation and participation within the ecosystem.

7. The method of claim 1, wherein the requirement for companies to purchase cryptocurrency coins from users to access data ensures a sustainable supply and demand economy for data.

8. The method of claim 1, wherein the removal of purchased coins from circulation helps control inflation and maintain the value of the platform's native cryptocurrency asset.

9. A computer-implemented system for connecting companies in need of data with individuals seeking to monetize data or other abstract commodities, comprising:
a. Authentication means verifying user identity within the platform;
b. Data production and sharing means allowing users to interact within the platform or with mining stations connected to the platform via API or another method of connection;
c. Data creation means enabling users to directly add data to the platform through surveys or other types of data collection;
d. Secure storage means for holding and managing user-generated data within the platform;
e. Data conversion means converting generated data into the platform's native cryptocurrency asset when required;
f. Marketplace means to facilitate the buying, selling, and accessing of data within the ecosystem;
g. Coin distribution means delivering cryptocurrency coins to users in exchange for providing data;
h. Coin purchase means requiring companies to buy cryptocurrency coins from users through a crypto exchange/open market to access the data;
i. Inflation control means removing and reintroducing purchased coins from circulation to maintain the value of the platform's native cryptocurrency asset.

10. The computer-implemented system of claim 9, wherein the platform provides user-controlled data-sharing options, allows users to decide whether to produce and share data within the platform or with mining stations.

11. The computer-implemented system of claim 9, wherein the platform enables the creation and answering of surveys to collect data directly from users, encouraging user participation in data generation.

12. The computer-implemented system of claim 9, wherein the platform ensures the security and privacy of user data by anonymizing and associating data with an internal ID and then converting data into the platform's native cryptocurrency asset before storing it.

13. The computer-implemented system of claim 9, wherein the platform acts as a secure marketplace, holding and managing user-generated data for potential future buyers.

14. The computer-implemented system of claim 9, wherein the distribution of cryptocurrency coins to users incentivizes data generation and participation within the ecosystem.

15. The computer-implemented system of claim 9, wherein the requirement for companies to purchase cryptocurrency coins from users to access data ensures a sustainable supply and demand economy for data.

16. The computer-implemented system of claim 9, wherein the removal of purchased coins from circulation helps control inflation and maintain the value of the platform's native cryptocurrency asset.

17. A non-transitory computer-readable storage medium storing a set of instructions for executing a method to connect companies in need of data with individuals seeking to monetize data or other abstract commodities, comprising the steps of:
a. Authenticating users within the platform;
b. Providing the option for users to produce and share data within the platform or with mining stations connected to the platform via API or another method of connection;
c. Allowing users to directly add data to the platform by creating and answering surveys or collecting data gathered through the platform;
d. Storing the data securely within the platform for future access or potential sale;
e. Converting generated data into the platform's native cryptocurrency asset when required;
f. Holding the data in a marketplace-like ecosystem, enabling users to access or sell the data;
g. Distributing cryptocurrency coins to users in exchange for providing data;
h. Requiring companies to purchase cryptocurrency coins from users through a crypto exchange/open market to access the data;
i. Controlling inflation by removing purchased coins from circulation and reintroducing them when all coins are mined, thereby supporting the new economy and ecosystem backed by data as the currency.

18. The non-transitory computer-readable storage medium of claim 17, wherein the platform offers users the ability to choose whether to produce and share data within the platform or with mining stations, providing users with control over their data sharing.

19. The non-transitory computer-readable storage medium of claim 17, wherein the platform facilitates the creation and answering of surveys to collect data directly from users, enabling users to participate in data generation.

20. The non-transitory computer-readable storage medium of claim 17, wherein the platform ensures the security and privacy of user data by anonymizing and associating data with an internal ID and then converting data into the platform's native cryptocurrency asset before storing it.

21. The non-transitory computer-readable storage medium of claim 17, wherein the platform acts as a secure marketplace, holding and managing user-generated data for potential future buyers.

22. The non-transitory computer-readable storage medium of claim 17, wherein the distribution of cryptocurrency coins to users incentivizes data generation and participation within the ecosystem.

23. The non-transitory computer-readable storage medium of claim 17, wherein the requirement for companies to purchase cryptocurrency coins from users to access data ensures a sustainable supply and demand economy for data.

24. The non-transitory computer-readable storage medium of claim 17, wherein the removal of purchased coins from circulation helps control inflation and maintain the value of the platform's native cryptocurrency asset.
